(19) United States
(12) Patent Application Publication
(10) Pub. No.: US 2022/0350986 A1
(43) Pub. Date: Nov. 3, 2022

(54) RECEIPT CAPTURE

(71) Applicant: Intuit Inc., Mountain View, CA (US)

(72) Inventors: Happy Bhairuprasad Somani, Fremont, CA (US); Di Wang, Foster City, CA (US); Kiran Kumar Reddy Digavinti, San Jose, CA (US); Sanjay Ramakrishna, Mountain View, CA (US)

(73) Assignee: Intuit Inc., Mountain View, CA (US)

(21) Appl. No.: 17/246,467

(22) Filed: Apr. 30, 2021

(51) Int. Cl. G06K 9/00; G06K 9/32; G06K 9/20

(52) U.S. Cl. CPC G06K 9/00469; G06K 9/00456; G06K 9/32; G06K 9/2063; G06K 2209/01

(57) ABSTRACT

A method including receiving an electronic record including a scan of a physical document. A coordinate system, unique to the electronic record, is established for the scan. A first boundary, defined according to the coordinate system, is generated automatically around a first set of recognized characters in the scan. A second boundary, defined according to the coordinate system, is generated automatically around a second set of recognized characters in the scan. The first set of recognized characters are physically separated in the scan by at least a predetermined distance with respect to the coordinate system. A comparison value is generated automatically by comparing a first location of the first boundary to a second location of the second boundary, relative to the coordinate system. The first set of recognized characters is associated, in storage, with the second set of recognized characters, responsive to the comparison value satisfying a rule.

### BACKGROUND

Many daily transactions are memorialized by physical receipts printed at the time of purchase. The physical receipts may be crumpled, smudged, or have other imperfections that make automatic receipt capture difficult.

### SUMMARY

The one or more embodiments provide for a method. The method includes receiving an electronic record including a scan of a physical document. The method also includes establishing a coordinate system, unique to the electronic record, for the scan. The method also includes generating, automatically, a first boundary, defined according to the coordinate system, around a first set of recognized characters in the scan. The method also includes generating, automatically, a second boundary, defined according to the coordinate system, around a second set of recognized characters in the scan. The first set of recognized characters are physically separated in the scan by at least a predetermined distance with respect to the coordinate system. The method also includes generating, automatically, a comparison value by comparing a first location of the first boundary to a second location of the second boundary, relative to the coordinate system. The method also includes associating, in storage, the first set of recognized characters with the second set of recognized characters, responsive to the comparison value satisfying a rule.

The one or more embodiments also provide for a system. The system includes a data repository storing an electronic record including a scan of a physical document. The data repository also stores a coordinate system, unique to the electronic record, for the scan. The data repository also stores a first boundary, defined according to the coordinate system, around a first set of recognized characters in the scan. The data repository also stores a second boundary, defined according to the coordinate system, around a second set of recognized characters in the scan. The first set of recognized characters are physically separated in the scan by at least a predetermined distance with respect to the coordinate system. The data repository also stores a comparison value that quantifies a degree of difference, relative to the coordinate system, between a first location of the first boundary and a second location of the second boundary. The data repository also stores a rule that quantitatively defines when the first set of recognized characters is deemed associated with the second set of recognized characters. The system also includes a processor in communication with the data repository. The system also includes an application services platform configured, when executed by the processor, to receive the electronic record. The application services platform is also configured to establish the coordinate system. The application services platform is also configured to generate, automatically, the first boundary and the second boundary. The application services platform is also configured to generate, automatically, the comparison value by comparing the first location of the first boundary to a second location of the second boundary. The application services platform is also configured to determine that the comparison value satisfies the rule. The application services platform is also configured to associate, in the data repository, the first set of recognized characters with the second set of recognized characters when the rule is satisfied.

The one or more embodiments also provide for a non-transitory computer readable storage medium storing program code, which when executed by a processor, performs a computer-implemented method. The computer-implemented method includes receiving an electronic record including a scan of a physical document;

The computer-implemented method also includes establishing a coordinate system, unique to the electronic record, for the scan;

The computer-implemented method also includes generating, automatically, a first boundary, defined according to the coordinate system, around a first set of recognized characters in the scan;

The computer-implemented method also includes generating, automatically, a second boundary, defined according to the coordinate system, around a second set of recognized characters in the scan. The first set of recognized characters are physically separated in the scan by at least a predetermined distance with respect to the coordinate system;

The computer-implemented method also includes generating, automatically, a comparison value by comparing a first location of the first boundary to a second location of the second boundary, relative to the coordinate system; and

The computer-implemented method also includes associating, in storage, the first set of recognized characters with the second set of recognized characters, responsive to the comparison value satisfying a rule.

Other aspects of the one or more embodiments will be apparent from the following description and the appended claims.

### BRIEF DESCRIPTION OF DRAWINGS

FIG. 1A shows a computing system, in accordance with one or more embodiments.

FIG. 1B shows a data repository and data structure for electronically defining a scan of a document, in accordance with one or more embodiments.

FIG. 2A, FIG. 2B, FIG. 2C, and FIG. 2D show flowcharts for associating and categorizing sets of recognized characters of a scan of a document, in accordance with one or more embodiments.

FIG. 3 shows an architecture for associating and categorizing sets of recognized characters of a scan of a document, in accordance with one or more embodiments.

FIG. 4 shows an example of a scan of a document, in accordance with one or more embodiments.

FIG. 5A, FIG. 5B, FIG. 5C, FIG. 5D, and FIG. 5E show flowcharts for associating and categorizing sets of characters in the scan of FIG. 4, in accordance with one or more embodiments.

FIG. 6A and FIG. 6B show a computing system and network environment, in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the one or more embodiments. However, to one of ordinary skill in the art, the one or more embodiments may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For a non-limiting example, two angles may be “about congruent” if the values of the two angles are within ten percent of each other. However, if an engineer determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

In general, the one or more embodiments relate to technical functionality for associating recognized sets of characters in a scan of a physical document and for categorizing the sets of characters. The one or more embodiments address a problem that arises when a user desires to categorize information in a physical document that suffers from physical defects. For example, a user has a physical receipt that is partially wrinkled, crumpled, and smudged. However, the receipt contains information regarding money spent on a transaction, with the details of the transaction subdivided into transaction types and dollar amounts associated with the transaction types. While optical character recognition (OCR) can be used to recognize the characters present in a scan of the receipt, the physical defects in the receipt can result in errors in optical character recognition or in associating the set of recognized characters representing the category type with the set of recognized characters representing the dollar value for that category type. For example, a computer cannot recognize from OCR alone that the “tax” portion of the receipt is associated with the characters “$3.83”. Thus, often a computer cannot accurately scan the receipt and then automatically associate sets of characters and categorize transactions automatically.

The one or more embodiments address these and other technical issues. Initially, OCR is performed on a physical document. Then, a unique coordinate system is automatically established for the scan of the physical document. One or more boundary boxes or boundary polygons are drawn around sets of recognized characters in the scan based on physical distances on the unique coordinate system. The positions of the boundary boxes are then associated with each other based on the boundary boxes' locations relative to each other and the boundary boxes' locations within the overall document. The locations are defined relative to the unique coordinate system. Rules then determine which sets of recognized characters are associated with each other. Categorization of information in the document can then be performed by other rules based on which sets of recognized characters are associated with each other.

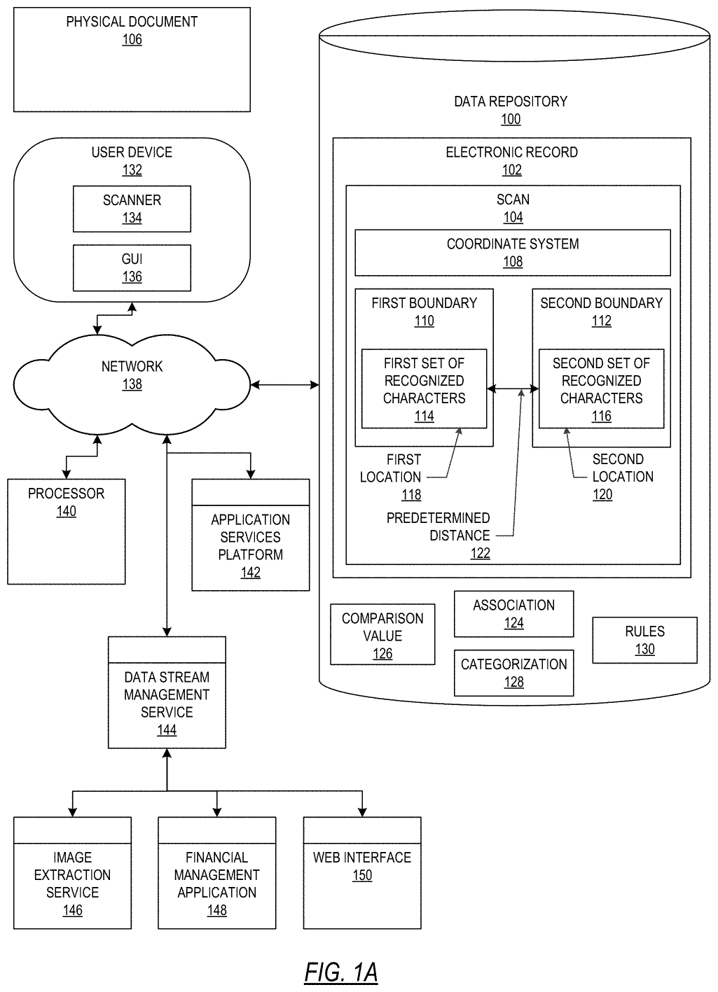

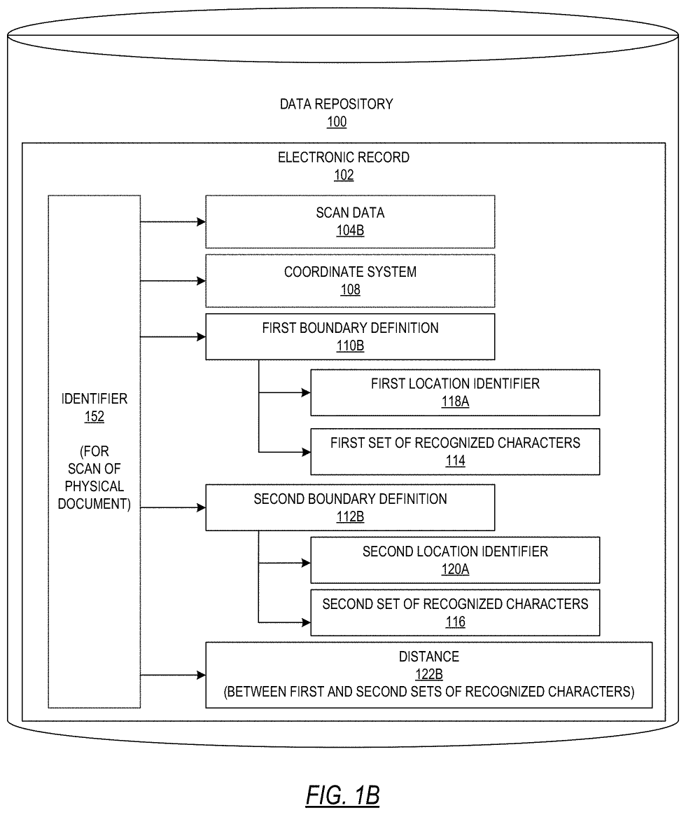

Attention is now turned to the figures. FIG. 1A and FIG. 1B show a computing system, including a data repository and a data structure, in accordance with one or more embodiments. The computing system includes a data repository (100). In one or more embodiments, the data repository (100) is a storage unit and/or device (e.g., a file system, database, collection of tables, or any other storage mechanism) for storing data. The data repository (100) may include multiple different storage units and/or devices. The multiple different storage units and/or devices may or may not be of the same type and may or may not be located at the same physical site.

The data repository (100) stores computer-readable information, including an electronic record (102). The electronic record (102) is computer-readable data that is a record of the extracted contents of a scan (104), and possibly metadata derived therefrom. The scan (104) is defined as data which a computer can use to display or construct an image of a physical document (106). In turn, the physical document (106) is defined as an object having imprinted or embossed characters. For example, the physical document (106) may be a paper receipt imprinted with ink that has been shaped into human-readable characters. In another example, the physical document (106) may be a plastic token with characters embossed or etched into the plastic. In still another example, the physical document (106) may be a cloth tag having characters stitched therein.

The electronic record (102) also contains the definition of a coordinate system (108). The coordinate system (108) is defined as a multi-axis graph defined with respect to a selected orientation the scan (104). The origin of the graph is defined at a corner of the scan (104) of the physical document (106). For example, the far upper left corner of the image defined by the scan (104) may be designated as the origin of the graph.

The scale of the graph is defined by groups of pixels in the scan (104). Thus, for example, 250 pixels (or some other value) could be assigned to a distance of “1” along one axis of the graph. For a two dimensional graph, the other axis of the graph may be similarly defined in groups of pixels, though the number of pixels that form a distance unit of “1” along one axis may be different along another axis. The number of pixels that define a distance unit of “1” may vary from scan to scan. However, within any given scan, such as the scan (104), the number of pixels along each axis that define a distance unit of “1” may be consistent. However, if finer detail is needed in some sections of the scan (104) in order to resolve smudges or other defect in the image of the physical document (106), then a distance of “1” may be sub-divided by specifying smaller numbers of pixels within the distance of “1”.

Other techniques may be used to define the coordinate system (108). For example, if a scale is available next to the physical document (106), then the scale may be used to define a distance of “1” along the axes of the coordinate system (108). The scale may be a ruler, a measurement of distance taken by the scanning device and added to the scan (104), or an object having a known length (such as a coin or paper money).

The coordinate system (108) is unique to the scan (104). Thus, a different coordinate system is defined for each different scan, even if two scans are of the same physical document.

A first boundary (110) and a second boundary (112) are defined for the scan (104). A boundary, such as the first boundary (110) and the second boundary (112), is defined as a perimeter of a polygon drawn around a set of recognized characters. Thus, the first boundary (110) is a perimeter of a polygon drawn around a first set of recognized characters (114) in the scan (104). Similarly, the second boundary (112) is another perimeter of another polygon drawn around a second set of recognized characters (116) in the scan (104). A polygon, as used herein, is a continuous, possibly irregular shape. The polygon may have curved sections, and thus may or may not have vertices. In a simple example, a polygon may be a rectangle drawn around a set of recognized characters that a human would consider to be a “word.”

As used herein, a “recognized character” is a character in the scan (104) that has been recognized using OCR. In particular, a “recognized character” is defined as computer readable data that can instruct a computer to recognize that the computer-readable data corresponds to a particular symbol (such as an alphanumeric character, a special character, pictorial character, etc.). Accordingly, as used herein, a “set of recognized characters” is one or more recognized characters that are associated with each other by being contained within a boundary.

The first boundary (110) defines a first location (118) in the scan (104). The first location (118) therefore defines a section of the scan (104) that has a quantified place in the scan with respect to the coordinate system (108). Similarly, the second boundary (112) defines a second location (120) in the scan (104).

A distance may separate the first boundary (110) and the second boundary (112) in the scan (104). The distance is defined as a number of units along the coordinate system (108) between selected points defined with respect to the first boundary (110) and the second boundary (112). For example, the distance may be defined as the distance between the nearest portions of the first boundary (110) and the second boundary (112). The distance may be also defined as the distance between a first center of the first boundary (110) and a second center of the second boundary (112). However, the distance is defined, the distance is quantifiably and repeatably ascertainable.

The data repository (100) also stores a predetermined distance (122). The predetermined distance (122) is a distance, as defined above, that represents a minimum distance between the first set of recognized characters (114) and the second set of recognized characters (116) to be considered different sets of recognized characters. For example, the predetermined distance (122) may be a pre-determined length in the scan (104) in which only whitespace or background images are present, but in which no recognized characters exist. In this manner, the predetermined distance (122) sets a definition that allows the computer to determine which recognized characters should be grouped together to be considered part of a recognized set of recognized characters.

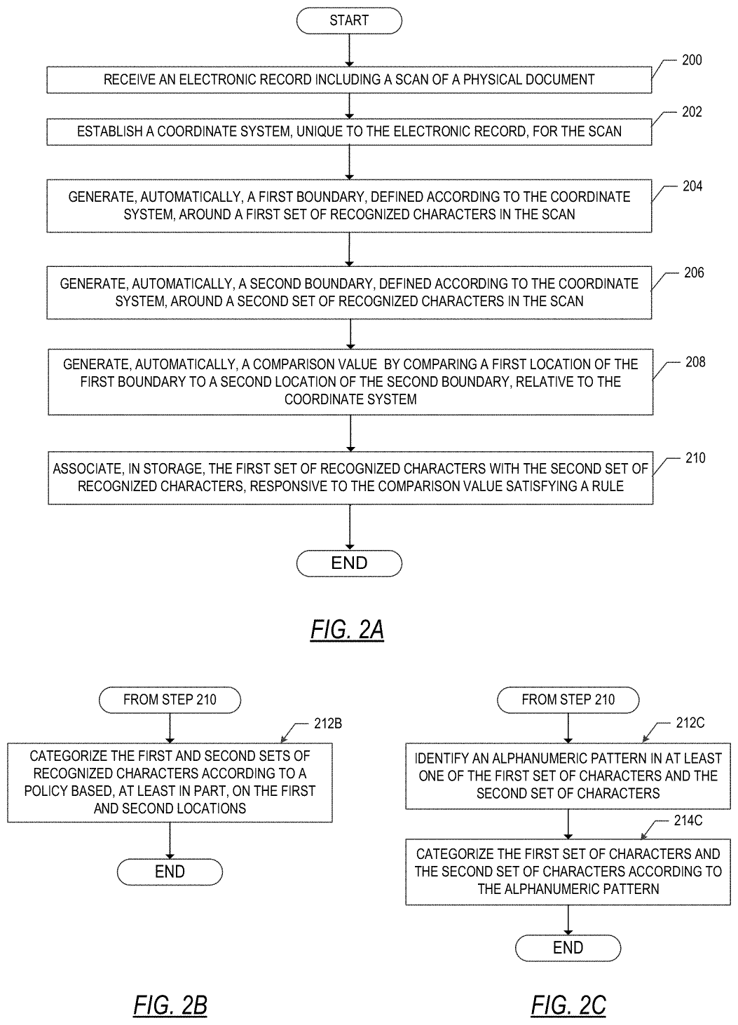

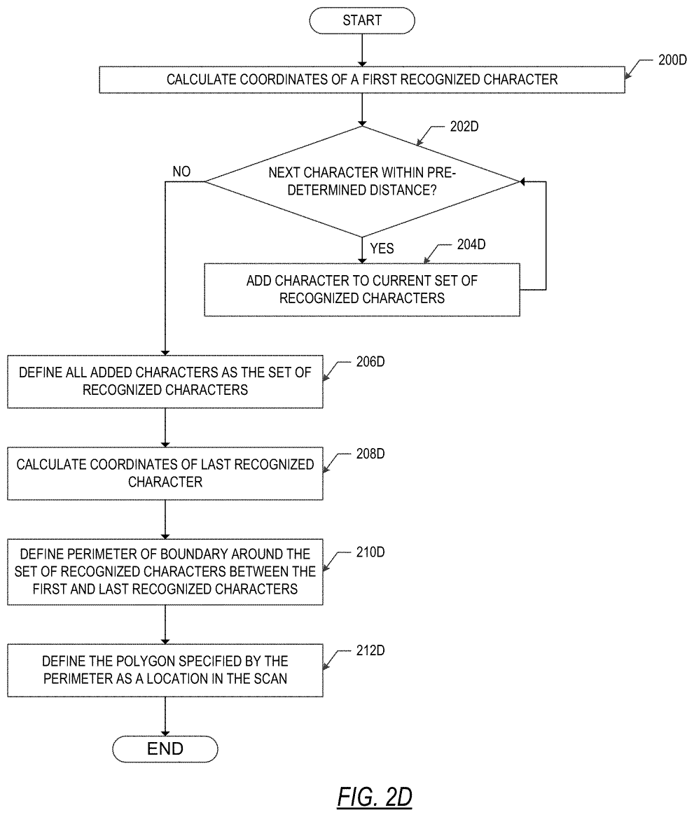

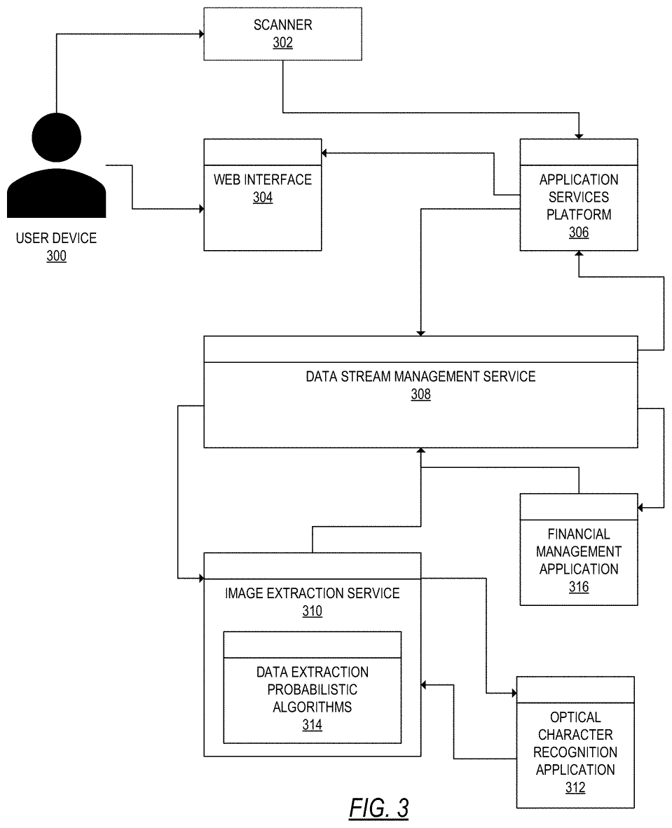

The data repository (100) may also store other information. For example, the data repository (100) may also store an association (124). The association (124) is defined as computer-readable data that specifies a relationship between two different sets of recognized characters. Thus, for example, the association (124) may be data that specifies that the first set of recognized characters (114) has a known relationship with the second set of recognized characters (116). In a specific example, the first set of recognized characters (114) may be the characters that form the word “tax” and the second set of recognized characters (116) may be the characters that form the number “3.83.” The association (124), in this specific example, is data that defines that the set of recognized characters “tax” is a type of category and the set of recognized characters “3.83” is a value for the category. In this way, the first set of recognized characters (114) is associated with the second set of recognized characters (116), as defined by the association (124). Establishing the association (124) is explained with respect to FIG. 2A through FIG. 2D and exemplified in FIG. 3 through FIG. 5E.

The data repository (100) also stores a comparison value (126). The comparison value (126) is defined as computer readable data that quantitatively defines the relationship between the first location (118) of the first boundary (110) and the second location (120) of the second boundary (112), relative to the coordinate system. The comparison value (126) is generated according to the techniques described with respect to FIG. 2A through FIG. 2E.

However, briefly, the comparison value (126) is generated by comparing how the first boundary (110) relates to the second boundary (112) within the coordinate system (108). For example, the first boundary (110) and the second boundary (112) may lie in the same horizontal plane, as defined with respect to the coordinate system (108). In another example, the first boundary (110) and the second boundary (112) may be in different horizontal or vertical planes, as defined with respect to the coordinate system (108). As described further below, the relative placement of the first boundary (110) and the second boundary (112) within the coordinate system (108) of the scan (104) can be used to establish qualitative relationships between different sets of recognized characters and to categorize one or more of the sets of recognized characters.

Thus, the data repository (100) may also store a categorization (128). The categorization (128) is defined as a category assigned to one or more of the sets of recognized characters. For example, if the first set of recognized characters (114) is the word “tax”, then the categorization (128) for the first set of recognized characters (114) is a “tax” category. The first set of recognized characters (114) is associated electronically with the categorization (128) “tax”.

The categorization (128), the association (124), and the comparison value (126) may be performed or calculated according to one or more rules (130). The rules (130) are defined as program code configured to perform a functionality, as described with respect to FIG. 2A through FIG. 2E. The rules (130) may include one set of rules for performing the categorization (128), another set of rules for performing the association (124), and another set of rules for determining the comparison value (126). The algorithms shown in FIG. 2A through FIG. 2E may be embodied as program code, and thus represent examples of the rules (130). An example of one of the rules (130) may be an alignment criterion between the first location (118) and the second location (120), relative to the coordinate system (108). For example, if the locations lie along the same plane or are located in particular places within the scan (104) of the physical document (106), then the alignment criterion might be met.

The term “rules” is synonymous with the term “policies”. Thus, in an embodiment, the rules (130) may be expressed as one or more policies. A policy may take a variety of different forms. For example, a policy may be a set of probabilities that the first set of recognized characters belongs to a selected category type, from among two or more category types, based on a vertical distance down from an origin of coordinate system.

In addition to the data repository (100) and the physical document (106), FIG. 1 shows other components of a computing system. For example, FIG. 1 also shows a user device (132). The user device (132) is a computer, such as a mobile phone, a laptop, a desktop, or some other kind of computer.

The user device (132) includes a scanner (134) and a GUI (136). The scanner (134) is a camera or other optical reader. The scanner (134) may also include the software useable to operate the camera and/or to recognize images. The GUI (136) is a graphical user interface (“GUI”) of the user device (132). The GUI (136) is the graphical representation of components of the software of the user device (132), and may include also images taken by the scanner (134). The GUI (136) may have one or more widgets. A widget is an interactive tool in the GUI (136). For example, a widget may be a button, a drop-down menu, a slider, or some other selection mechanism that a user may interact with when using the software installed on the user device (132).

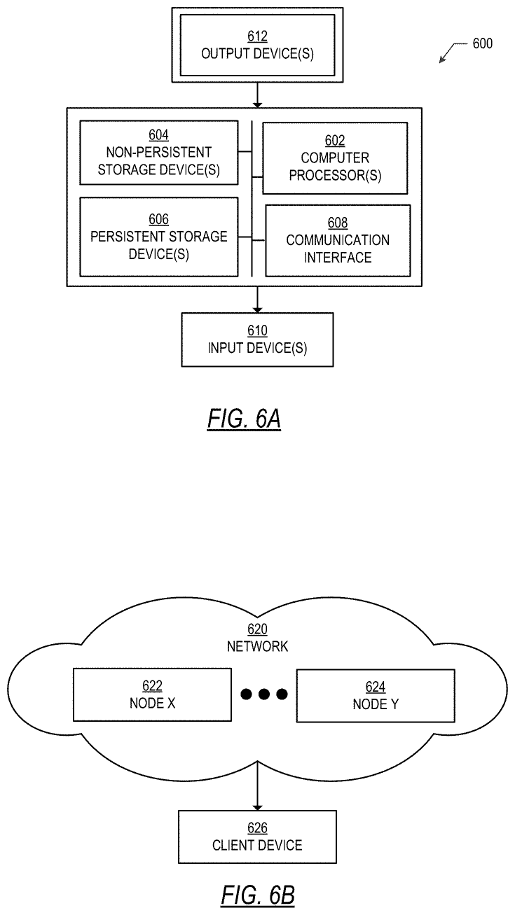

The system shown in FIG. 1 also includes a network (138). The network (138) is one or more additional computers or computing-related devices, other than the user device (132), and the wired or wireless communications that enable communication between the multiple computers. Thus, the network (138) allows communication between the data repository (100), the user device (132), and one or more remote processors, such as processor (140). Additional details relating to the network (138) are described with respect to FIG. 6.

The system shown in FIG. 1 also includes a processor (140). The processor (140) is a one or more computer processors configured to execute program code to accomplish the functions and algorithms described with respect to FIG. 2 through FIG. 5E. Additional details regarding the processor (140) are described with respect to FIG. 6. The processor (140) is also configured to execute the software applications and platforms described below, including the application services platform (142), the data stream management service (144), the image extraction service (146), the financial management application (148), and the web interface (150).

The application services platform (142) is one or more software applications that, when executed, coordinate access of the user device (132) to the other software functions of the system. The other software functions may include the data stream management service (144), the image extraction service (146), the financial management application (148), and the web interface (150). The web interface may be a web browser or an application on a user device. Operation of the application services platform (142) is described with respect to FIG. 3.

The data stream management service (144) is one or more software applications that, when executed, coordinate communication between the data stream management service (144), the network (138), and other cloud-based services such as the image extraction service (146), the financial management application (148), and/or the web interface (150). An example of the data stream management service (144) is KAFKA® by the Apache Software Foundation. Thus, the data stream management service (144) may provide a framework implementation of a software bus using stream processing. Operation of the data stream management service (144) is described with respect to FIG. 3.

The image extraction service (146) is one or more software applications that, when executed, extract information from images from a picture taken by, for example, the user device (132). Thus, the image extraction service (146) receives the scan (104) as input, and produces as output the coordinate system (108), the first set of recognized characters (114), the second set of recognized characters (116), and other information relating to the scan (104). The image extraction service (146) may use optical character recognition (OCR) technology to recognize the first set of recognized characters (114) and the second set of recognized characters (116).

The image extraction service (146) may perform other functions with respect to the scan (104). For example, as described with respect to FIG. 2A, the image extraction service (146) may establish the coordinate system (108) for the scan (104) and draw the boundaries for the locations (e.g., the first boundary (110) at the first location (first location (118) and the second boundary (112) and the second set of recognized characters (116)).

In an embodiment, the image extraction service (146) executes as a cloud-based service coordinated by the data stream management service (144). Operation of the image extraction service (146) is described with respect to FIG. 3.

The financial management application (148) is one or more software applications that, when executed, assist a user to manage, store, and analyze financial information. The financial management application (148) may be used to categorize information extracted by the image extraction service (146). Thus, the financial management application is executable by a processor to categorize the first set of recognized characters (114) and the second set of recognized characters (116) according to a policy (e.g. one or more of the rules (130)) based, at least in part, on the first location (118) and the second location (120). For example, if the image extraction service (146) determines that the characters “tax” are associated with “3.83”, then the financial management application (148) may be programmed to categorize the expense “3.83” as a “tax” for a “business transaction.” Because the locations were used to associate “tax” with “3.83”, the resulting categorizations by the financial management application (148) are also based on the locations of the first boundary (110) and the second boundary (112).

The financial management application (148) may be operated separately from any of the other applications described with respect to FIG. 1 (e.g., have different owners and executed by physically different servers). The financial management application (148) may generate the categorization (128) described above. Operation of the financial management application (148) is described further with respect to FIG. 3.

The web interface (150) is one or more software applications that, when executed, coordinate information presented to the user device (132) via the GUI (136). Thus, for example, the web interface (150) may present the scan (104), the comparison value (126), the association (124), and/or the categorization (128) to a user for verification. A user may interact with the web interface (150) via one or more widgets in the GUI (136).

Attention is now turned to FIG. 1B. FIG. 1B shows an alternative arrangement of the information stored in the data repository (100) shown in FIG. 1. Thus, reference numerals common to FIG. 1A and FIG. 1B relate to similar components having similar definitions. The data repository (100) shown in FIG. 1B reflects one possible data structure or technical architecture for storing the information described with respect to FIG. 1A.

In particular, the electronic record (102) is composed of various types of data that are related by an identifier (152). The identifier (152) is an alphanumeric sequence of numbers, possibly expressed in binary format, that uniquely identifies the electronic record (102) from among other electronic files that store information relating to an individual scan.

The electronic record (102) includes scan data (104B) that is a sequence of numbers, possibly expressed in a binary format, that describes the information contained in the scan (104). In other words, the scan data (104B) is the information that a computer can read to display the image of the scan on the GUI (136), as well as the information from which the image extraction service (146) can extract recognized characters.

The electronic record (102) also includes the coordinate system (108). Thus, the coordinate system (108) is expressed as a data set, different than the scan data (104B), that defines the origin and various coordinates of points on the scan (104).

The electronic record (102) also includes a first boundary definition (110B). The first boundary definition (110B) is computer readable data that defines where, on the coordinate system (108), the first boundary (110) is located. Similarly, the second boundary definition (112B) is computer readable data that defines where, on the coordinate system (108), the second boundary (112) is located.

A first location identifier (118A) is associated with the first boundary definition (110B). The first location identifier (118A) is a sequence of numbers, possibly expressed in binary format, that uniquely identifies the first boundary definition (110B). Similarly, a second location identifier (120A) is another sequence of numbers, possibly expressed in binary format, that uniquely identifies the second boundary definition (112B).

A distance (122B) is also associated with the identifier (152). The predetermined distance (122) is a recorded distance, relative to the coordinate system (108), between pre-defined points for the first boundary definition (110B) and the second boundary definition (112B), as described above with respect to the predetermined distance (122). The distance (122B) is compared to the predetermined distance (122) as part of determining whether any given recognized character should be included within a particular set of recognized characters.

The distance (122B) may also be used in determining whether the first set of recognized characters (114) is related to the second set of recognized characters (116). For example, if the distance (122B) between boundaries is within some range of distances, then a determination may be made according to the rules (130) that the first set of recognized characters (114) and the second set of recognized characters (116) should be associated with each other.

While FIG. 1A and FIG. 1B show a configuration of components, other configurations may be used without departing from the scope of the one or more embodiments. For example, various components may be combined to create a single component. As another example, the functionality performed by a single component may be performed by two or more components.

FIG. 2A, FIG. 2B, FIG. 2C, and FIG. 2D are flowcharts, in accordance with one or more embodiments. The methods shown in FIG. 2A through FIG. 2D may be performed using the system shown in FIG. 1 and/or using the computer and network environment described with respect to FIGS. 6A and 6B.

Step 200 includes receiving an electronic record including a scan of a physical document. The electronic record may be received from a scanner of a user device via a web interface. The electronic record is received at an application services platform and is passed via a data stream management service to an image extraction service. Ultimately, the scan is received as a partially completed electronic record at the image extraction service. The scan is deemed “partially completed” because, as shown in FIG. 1, the electronic record may include data such as the coordinate system (108), the first boundary (110), the second boundary (112), and possibly other information. However, initially, the scan (104) does not include the enumerated information because enumerated information has not yet been generated by the image extraction service (146) and/or other services as described with respect to FIG. 1.

Step 202 includes establishing a coordinate system, unique to the electronic record, for the scan. The coordinate system is established using the image extraction service, but may be established using other software or other services operating either locally or in the cloud. The coordinate system is established by defining an origin, defining a number of axes, and then defining a unit length along the axes.

The image extraction service establishes the origin by selecting an origin point in the scan. The origin point in the scan may be any point. However, in an embodiment, the upper left corner of the scan (from the perspective of a human viewer) may be designated as the origin. The origin is the point where all subsequently defined axes are defined as having a value of zero.

The image extraction service establishes the one or more axes by defining one or more orthogonal lines extending from the origin. In many cases, the scan is a two dimensional image, in which case two axes are used (e.g., “x” and “y” axes). The axes are orthogonal (i.e., perpendicular) to one other. One axes (e.g. the “x” axis) is defined as horizontal and the other axis (e.g. the “y” axis) is defined as vertical. In other embodiments, only a single axis may be specified in order to increase the speed of processing or for some other reasons. Alternatively, for a three-dimensional image, three axes may be specified (e.g., a “z” axis that is defined as into and/or out of a given x-y plane). The labeling or numerical representations of the axes may be changed. For example, on the “x” axis numbers may increase from left to right (or vice versa) while on the “y” axis values may increase from top to bottom (or vice versa). In some embodiments, the origin need not be set to (0,0), but may be set to some other number.

The image extraction service also establishes the unit length along any given axis. A unit length may be an arbitrary value. Thus, for example, any scale could be used with respect to the scan. However, in an embodiment, the unit length may be defined in terms of a number of pixels. For example, every 100 pixels may be defined as a until length of “1”. In still another example, a scale may be established by reference to some other object in the scan having a known size. For example, if a ruler (or other object of known dimensions) is present in the image of the scan, then the unit length may be expressed in absolute terms, such as millimeters, micrometers, etc.

Step 204 includes generating, automatically, a first boundary, defined according to the coordinate system, around a first set of recognized characters in the scan. A method for defining the first boundary is described with respect to FIG. 2D.

Step 206 includes generating, automatically, a second boundary, defined according to the coordinate system, around a second set of recognized characters in the scan. Again, the method for defining the second boundary is described with respect to FIG. 2D.

Step 208 includes generating, automatically, a comparison value by comparing a first location of the first boundary to a second location of the second boundary, relative to the coordinate system. The comparison value is generated by selecting a first point on the first boundary and selecting a second point on the second boundary. In an example, the first point and the second point are on portions of the boundaries that are closest to each other. In another example, the first and second points are the centers of the two boundaries. In still another example, the first and second points are selected according to a weighted formula that preferentially shifts the first and second points along one or more axes of the coordinate system.

A numerical difference is then automatically calculated between the first and second points. The numerical difference is the comparison value, in this example.

For example, the first and second locations may be associated with each other when the first and second locations lie along the same line relative to one of the axes of the coordinate system. Thus, in this example, the comparison value is determined based on the first and second locations lying along the same line. As described in the next step 210, the comparison value can result in an association or conclusion that the first and second locations are associated with each other.

Step 210 includes associating, in storage, the first set of recognized characters with the second set of recognized characters, responsive to the comparison value satisfying a rule. As described above, when the comparison value satisfies a rule, then an association can be made between to different sets of recognized characters (one set in the first location and the other set in the second location). For example, the characters “tax” (a first set of recognized characters) is associated with the characters “3.83” (a second set of recognized characters) responsive to the comparison value (the first location of the first set of recognized characters lies along the same line as the second location of the second set of recognized characters) satisfying a rule (the rule specifying that when the comparison value is “true” then the two sets of recognized characters are to be associated).

A variety of rules may be present. In some cases, two or more comparison values satisfy one or more rules.

Using the method of FIG. 2A, it is possible to mitigate the difficulty of automatic processing of images of crinkled or crumpled physical documents, smudged characters, etc. In other words, by specifying the coordinate system, by recognizing characters, by drawing boundaries around sets of recognized characters, by generating comparison values between the boundaries, and by associating different sets of recognized characters, a computer can be programmed to empirically determine that sets of recognized characters should be associated. Some embodiments may determine association even when one or more imperfections exist in the scan, imperfections that would otherwise make it impossible or impracticable for an ordinary computer to recognize which sets of characters should be associated with each other. Thus, the method of FIG. 2, and the other embodiments described herein, provide a technical means for improving a computer as a tool.

The one or more embodiments described with respect to FIG. 2A may be used to identify account numbers (e.g., credit card numbers, bank account numbers, routing numbers, etc.). For example, account numbers can be identified and checked by extracting the last 4 numbers of the card found on receipt. The card numbers, or partial card numbers, have well defined formats in most receipts. Thus, the position of an account number in the coordinate system may be used to associate a set of numbers found with an “account”. The identified numbers, and associated account, can then be leveraged to match up with the bank accounts or credit cards connected to the users entries in a financial management application. Thus, the one or more embodiments can be used to reduce the risk of double counting an expenses for a user when categorizing the expense in the financial management application.

The method of FIG. 2A may be varied. For example, referring to FIG. 2B, further processing may be performed after step 210 of FIG. 2A. For example, step 212B may include categorizing the first set of recognized characters and the second set of recognized characters according to a policy based, at least in part, on the first location and the second location. The policy may be one of the rules (130) described with respect to FIG. 1.

For example, a first relative placement of the first location in the overall scan, relative to the coordinate system, is determined. Similarly, a second relative placement of the second location in the overall scan, relative to the coordinate system, is determined. Values are assigned to the first location and the second location to express the relative importance, merit, or likely type of information held in the respective location. For example, if the first location is disposed lower down in the scan, then a rule may specify a number that represents a likelihood that characters within the first location will reflect a particular category type, such as “total”. Similarly, if the second location is disposed higher up in the scan, then another rule may specify another number that represents a different likelihood that characters in within the second location will reflect a value for some other category type, such as “3.83” which is more likely to be associated with “tax” than total. The comparison value, in this particular case, is based on the relative placements of the first and second locations within the scan with respect to the coordinate system, and the comparison value indicates that the locations are associated with each other as relating to the same transaction, but not being directly related to each other.

If, however, the two locations lie along the same line in the coordinate system, then the “tax” is associated with the value “3.83”. In this manner, the first and second sets of recognized characters are categorized based at least in part on the first and second locations within the scan.

Still other variations are possible. For example, attention is turned to FIG. 2C, which is performed after step 210 of FIG. 2A.

Step 212C includes identifying an alphanumeric pattern in at least one of the first set of recognized characters and the second set of recognized characters. For example, the processor may be programmed to recognize a sequence of alphanumeric characters as a word, such as “tax” or “total”. The processor may also be programmed to recognize another sequence of alphanumeric characters as a dollar sign (“$”) followed by a sequence of numbers with a period disposed therein.

Step 214C then includes categorizing the first set of recognized characters and the second set of recognized characters according to the alphanumeric pattern. For example, the processor may be programmed to recognize words such as “tax” as a category for a financial management application, and to recognize a sequence of numbers followed by a dollar sign as a dollar value. The recognition of the pattern in the alphanumeric characters may be used to further categorize the first and second sets of characters. For example, even if the alignment of the “tax” characters and the “$3.83” characters were not aligned at step 212B of FIG. 2B, the one or more embodiments may nevertheless associate “tax” with “3.83” due to the detected sequences of characters.

Further comparison values are possible between three or more sets of characters. For example, alignment of locations of characters in the scan may set the characters “total” with “$20.33”, in which case it is more likely that the term “tax” should be associated with the other sequence of numbers, “$3.83”. Thus, in this example, a combination of the sequence of alphanumeric characters and locations of the recognized characters is used to categories the four sets of characters (“tax”, “total”, “$20.33”, and “$3.83”).

The combination of different methods of associating sets of characters can provide further resiliency against scanning errors caused by physical defects in the physical document. For example, the one or more embodiments may be used to program a computer to recognize and properly associate sets of characters from a scan of a crumpled or smudged receipt where the misalignments of sets of characters would ordinarily make it impossible for a computer to accurately recognize and associate sets of characters.

Attention is now turned to FIG. 2D. FIG. 2D is a method for drawing a boundary around a set of recognized characters. Thus, FIG. 2D is an example of how to accomplish steps 204 and/or 206 of FIG. 2A to generate the first boundary (110) and the second boundary (112) of FIG. 1A. Thus, step 200D through step 212D may be performed within step 204 or within step 206 of FIG. 2A.

Step 200D includes calculating coordinates of a first recognized character. For example, OCR may be performed on a document. Then, as described above, the position coordinates on the coordinate system may be identified for a single recognized character. In a specific example, the letter “T” may be identified as a single recognized character. A boundary is defined in the coordinate system that specifies a box that surrounds the recognized letter “T”.

Step 202D includes determining whether a next character (along one or more axes of the coordinate system) is within a pre-determined distance (of the first recognized character). The pre-determined distance is a distance, decided in advance or according to a rule, at which a subsequent character is defined to be excluded from the current set of recognized characters. The distance is measured between two recognized characters along one or more axes, ignoring any white space or unrecognized smudges.

If the distance is within the pre-determined distance (a “yes” determination at step 202D), then at step 204D the next character is added to the current set of recognized characters. Otherwise, at a “no” determination at step 202D, then at step 206D, all added characters are defined as the set of recognized characters.

Step 208D includes calculating coordinates, on the coordinate system, of the last recognized character. The calculation of the coordinates of the last recognized character may be performed in a manner similar to that described for step 200D.

Step 210D includes defining a perimeter of a boundary around the set of recognized characters between the first and last recognized characters. In other words, one or more lines are drawn around all of the characters between the first recognized character and the last recognized character. The computer expresses the lines in mathematical form. The one or more lines may take the form of a box, a circle, a rectangle, a complex shape, or other polygon shapes.

Step 212D includes defining the polygon specified by the perimeter as a location in the scan. In particular, the perimeter defined at step 210D is specified as a polygon, and the polygon is located within the scan according to the coordinate system. The polygon may be first boundary (110) described in FIG. 1A and the location of the polygon within the scan may be the first location (118) described in FIG. 1A.

While the various steps in the flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments. By way of an example, determination steps may not require a processor to process an instruction unless an interrupt is received to signify that condition exists in accordance with one or more embodiments. As another example, determination steps may be performed by performing a test, such as checking a data value to test whether the value is consistent with the tested condition in accordance with one or more embodiments. Thus, the one or more embodiments are not necessarily limited by the examples provided herein.

FIG. 3 through FIG. 5E present a specific example of the systems and techniques described above with respect to FIG. 1A through FIG. 2D. The following example is for explanatory purposes only and not intended to limit the scope of the one or more embodiments.

FIG. 3 shows a computer architecture for accomplishing the methods described with respect to FIG. 2A through FIG. 2E. Thus, FIG. 3 is an alternative architecture to the system shown in FIG. 1A and FIG. 1B.

A user device (300) engages a scanner (302) to take an image of a document. For example, a user may use a mobile phone (user device (300)) to engage a camera (scanner (302)) on the phone to take an image of a receipt. In other example, a user may use a laptop computer (user device (300)) to engage a wirelessly connected camera (scanner (302)) to scan a paper invoice.

Optionally, a user may interact with a widget of a web interface (304) to signal that the scan of the document is being made. In another option, the user may engage a widget of the web interface (304), which then sends a signal to the scanner (302) to take an image of the document. Optionally, the scan may already exist in the user device (300), in which case the user may engage a widget in the web interface (304) to upload the scan from the user device (300).

The scan taken by the scanner (302) is then transmitted to an application services platform (306). The application services platform (306) coordinates communications between the scanner (302) and the web interface (304). The application services platform (306) is particularly useful from an architectural perspective because the one or more embodiments contemplate many user devices, such as user device (300), all uploading or scanning documents for processing.

The application services platform (306) transmits the scan to a data stream management service (308). The data stream management service (308) in this example is KAFKA® by the Apache Software Foundation. However, other data stream management services could be used. The data stream management service (308) coordinates communications from among multiple different services and applications and ensures that scans from different users and data from different scans are not confused with each other.

The data stream management service (308) generates a data pipeline that sends the scan to an image extraction service (310). In turn, the image extraction service (310) accesses an optical character recognition application (312) to perform OCR on the scan. The optical character recognition application (312) outputs a recognized scan or recognized image for which characters have been recognized. The image extraction service (310) then may execute one or more data extraction probabilistic algorithms (314) to extract information from the recognized scan. For example, the data extraction probabilistic algorithms (314) may establish the coordinate system, generate boundaries around sets of recognized characters, and categorize sets of recognized characters, as described with respect to FIG. 2A through FIG. 2E.

The output of the image extraction service (310) is the electronic record (102) described with respect to FIG. 1A or FIG. 1B. The electronic record (102) is returned to the data stream management service (308). The data stream management service (308) may transfer the electronic record (102) to the application services platform (306), or to other services, such as a financial management application (316). The financial management application (316) categorizes the expenses recorded in the scan, as characterized and associated by the image extraction service (310).

The data stream management service (308) may also transmit data to the application services platform (306) for transmission back to the web interface (304). The web interface (304) can then present information to the user device (300), such as an indication that the document was successfully scanned, and the information therein categorized at the financial management application (316).

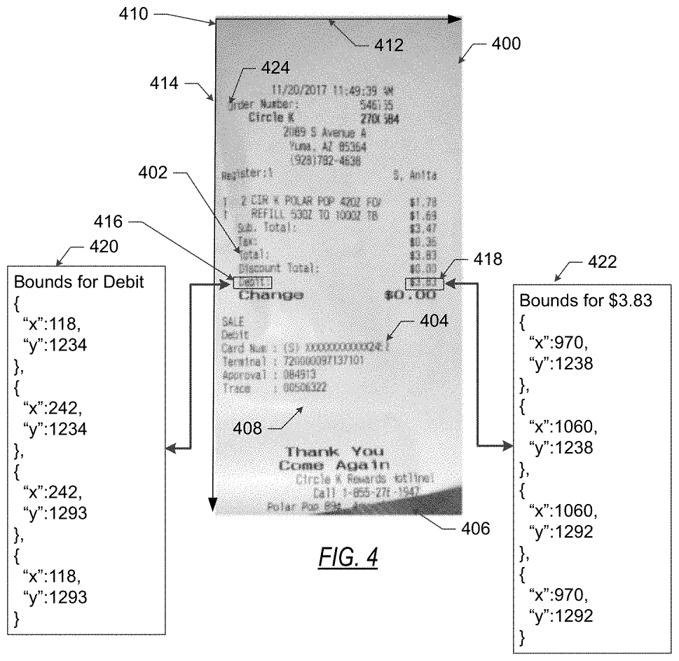

Attention is now turned to FIG. 4. FIG. 4 shows an example of a scan of a document. In particular, FIG. 4 is a scan of a receipt (400) for goods purchased at a gas station.

As shown in FIG. 4, the scan of the receipt (400) has defects. For example, crinkles in the paper of the receipt (400) are apparent at area (402). A smudge is present at area (404). A bend in the receipt (400) is shown at area (406). Warping is shown at area (408). Each of the areas, area (402), area (404), area (406), and area (408) represent defects in the receipt (400) that may interfere with a computer's ability to scan information from the receipt using normal OCR techniques.

In the example of FIG. 4, for the sake of simplicity of explanation, only two boundaries are drawn around two sets of characters for the receipt (400). However, it is contemplated that all sets of characters present in the receipt (400) will have boundaries drawn and that many different sets of recognized characters will be characterized or associated with respect to one or possibly many different other sets of recognized characters.

Either before or after performing OCR, a coordinate system is assigned to this particular scan of the receipt (400). The coordinate system includes an origin (410) in the upper left corner of the receipt, and two axes. The two axes are horizontal axis “x” (412) and vertical axis “y” (414). A unit length is established for the axes. The unit length is 10 pixels in this example. Thus, a distance of “1” along either axis will correspond to 10 pixels.

Two boundaries are drawn in FIG. 4, boundary A (416) and boundary B (418). Both boundaries are rectangles in this example. The recognized characters in boundary A (416) form the word “debit:”. The recognized characters in boundary B (418) form the symbols “$3.83”.

Each boundary is defined by coordinates on the coordinate system, expressed as distances along the two axes. Thus, for example, the corners defining the box drawn for boundary A (416) are shown in area (420). Each corner is defined by a position on the “horizontal axis “x” (412) and another position on the vertical axis “y” (414). Similarly, the corners defining the box drawn for boundary B (418) are shown in area (422).

The positions of the boundary A (416) and the boundary B (418) within the coordinate system can be used to associate the set of recognized characters represented by “debit” with the set of recognized characters represented by “$3.83.” For example, the fact that the boundary A (416) and the boundary B (418) lie, within a pre-determined margin of error, along the same plane relative to the horizontal axis “x” (412) indicates that the two sets of characters are more likely to be associated. Additionally, the fact that the set of recognized characters in boundary A (416) is further down the vertical axis “y” (414) relative to the coordinate system than, say, the set of characters that define the term “order” (424), also increases the probability that the term “debit” should be read as the word “debit” and also associated with the value of “$3.83” in boundary B (418). The increased probability due to location of the boundary occurs because most receipts have a standardized format.

Additionally, if the word “debit” incorrectly read “debi”, due to the fact that a smudge hid the letter “t”, the fact that the boundary A (416) is located where it is on the vertical axis “y” (414) increases the probability that the computer can categorize the recognized characters inside the boundary A (416) as being the word “debit.” Thus, the one or more embodiments provide for a means for programming a computer to correctly associate terms and values, and categorize them appropriately, even when defects are present in the receipt.

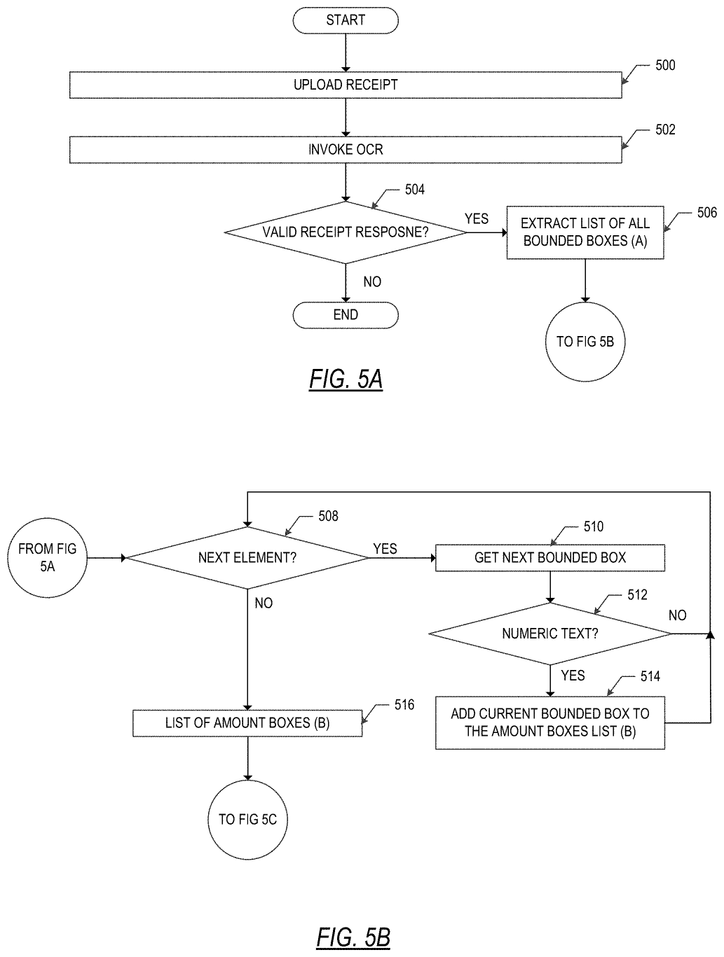

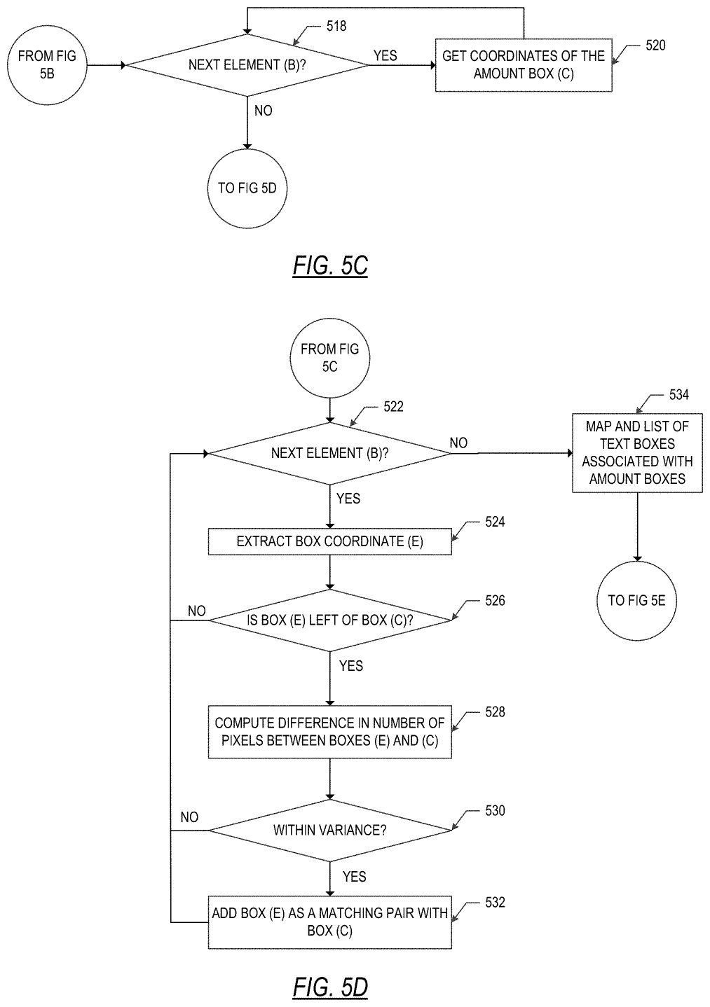

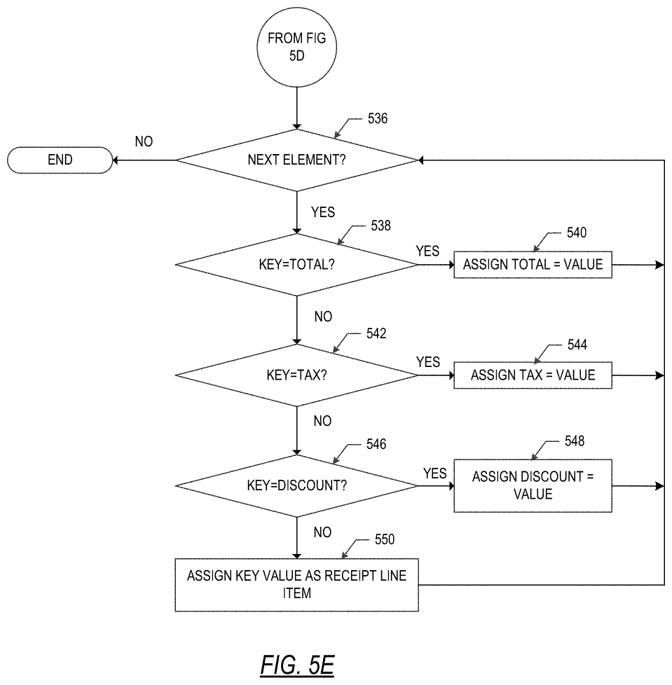

Attention is now turned to FIG. 5A through FIG. 5E. FIG. 5A through FIG. 5E together represent an alternative method to the methods described with respect to FIG. 2A through FIG. 2D. The method of FIG. 5A through FIG. 5E may be performed with respect to the scan of the receipt (400) shown in FIG. 4. FIG. 5A through FIG. 5E represents a single method, and thus reference numerals are treated accordingly. The method of FIG. 5A through FIG. 5E may be performed using the system shown in FIG. 1, the system shown in FIG. 3, and executed by the system shown in FIG. 6A and FIG. 6B.

At step 500, the receipt is uploaded. A user, Tom, takes a picture of the receipt with his mobile phone camera. Tom then uses a widget in a GUI on his mobile phone to upload the receipt to an application services platform, where processing begins. In turn, the application services platform transmits the scan of the receipt to a data stream management service, which coordinates the scan of the receipt with many other scans by different users. The scan of Tom's receipt is sent to an image extraction service.

At step 502, the image extraction service invokes an OCR application. The OCR application generates recognized characters on the receipt.

At step 504, a determination is made whether a valid receipt response is received. A valid receipt response is received if the scan of the receipt satisfies minimum conditions, such as whether a sufficient number of recognized characters are present, whether the quality of the scan is sufficient, whether the document is damaged beyond a certain degree, and/or combinations thereof. The minimum conditions are set by a computer scientist.

If the minimum conditions are not met (a “no” response at step 504), then the method terminates. Otherwise (a “yes” response at step 504), at step 506 a list of all bounded boxes is extracted. The list of all bounded boxes includes a total of “A” boxes. The method then passes to FIG. 5B.

Turning to FIG. 5B, at step 508 a determination is made whether a next element in the list of “A” boxes is to be processed. The answer at step 508 at the first iteration of FIG. 5B will be “yes”, because at least one bounded box will be present in the list.

In response to a “yes” determination at step 508, then at step 510 the next bounded box is retrieved for analysis (i.e., “get next bounded box). At step 512, a determination is made whether the recognized text in the bounded box is numeric text. If not (a “no” determination at step 512), then the process returns to step 508. If the text is numeric (a “yes” determination at step 512), then at step 514 the current bounded box is added to the “amount boxes list”, which is referred to as “B” in FIG. 5A through FIG. 5E. The process then returns to step 508.

At step 508, if no more elements are to be processed (a “no” determination at step 508), then at step 516, a list of “amount boxes” (labeled (B)) is generated. The process then proceeds to FIG. 5C.

Turning to FIG. 5C, at step 518 a determination is made whether to process the next element in the list of “amount boxes (B)”. If so (a “yes” determination at step 518), then at step 520 the coordinates of the “amount box” is received. The coordinates of the amount box are labeled as “C”. The term “C” represents all set of coordinates for the “amount boxes.” The process then returns to step 518. If the next element in the list of “amount boxes” (labeled (B)) is not present because all “amount boxes” in “B” have been processed (a “no” determination at step 518), then the process continues to FIG. 5D.

Attention is now turned to FIG. 5D. At step 522, a determination is made whether to process the next element in the “amount boxes” (labeled (B)). If so (a “yes” determination at step 522), then at step 524 the box coordinates (labeled “(E)”) are extracted.

At step 526, a determination is then made whether the box in (E) is to the left of the box in (C). In other words, a comparison value determination is made between the boundary box in the set (E) and the boundary box in the set (C), and the relative positions of the boundary boxes in the coordinate system is ascertained. Step 526 applies a rule (i.e., whether the boundary box in set (E) is to the left of the boundary box in set (C)). If not (a “no” determination at step 526), then the process returns to step 522 and repeats.

Otherwise (a “yes” determination at step 526), then at step 528 a difference is computed in the number of pixels separating (between) the boundary boxes in set (E) and the boundary boxes in set (C). In this example, the number of pixels is used as a unit of distance in the coordinate system for the scan.

At step 530, a determination is then made whether the difference computed in step 528 is within a predetermined variance. If not (a “no determination at step 530), then the process returns to step 522 and repeats. Otherwise, (a “yes” determination at step 530), then at step 532 the boundary box in the set (E) is associated as being one of a matching pair with the boundary box in the set (C). The process then returns to step 522 and again repeats.

Returning to step 522, in the event that there are no more boundary boxes in set (B) to be processed (a “no” determination at step 522), then at step 534, a map and list is generated. The map is a map of where the text boxes and the associated amount boxes are located in the scan of the document. The list is a list of the text boxes and the associated amount boxes. The process then continues to FIG. 5E.

Turning to FIG. 5E, at step 536 a determination is made whether to process the next element. An element is a pair of boxes, a “text box” and a corresponding associated “amount box”. The answer at step 536 is always “yes” at the first iteration, as at least one element will be present.

If the next iteration is to be processed (a “yes” determination at step 536), then at step 538 a determination is made whether the key (i.e., the set of characters) spells the word “total.” If so (a “yes” determination at step 538), then at step 540 the associated value in the number box is assigned as the value of the key “total”. The process then returns to step 536 and repeats.

Returning to step 538, if the key does not equal total (a “no” determination at step 538), then at step 542 a determination is made whether the key (i.e., the set of characters) spells the word “tax.” If so (a “yes” determination at step 542), then at step 544 the associated value in the number box is assigned as the value of the key “tax”. The process then returns to step 536 and repeats.

Returning to step 542, if the key does not equal tax (a “no” determination at step 542), then at step 546 a determination is made whether the key (i.e., the set of characters) spells the word “discount.” If so (a “yes” determination at step 546), then at step 548 the associated value in the number box is assigned as the value of the key “discount”. The process then returns to step 536 and repeats. Otherwise, (a “no” determination at step 546), then at step 550, the associated value in the number box is assigned as the value of the key for a “receipt line item.” The “receipt line item is some other category of expense in the receipt, other than “total”, “tax”, and “discount”. The process then returns to step 536 and repeats.

Returning to step 536, if the next element is not to be processed (a “no” determination at step 536), such as when all elements have been processed, then the method terminates. The processing of the receipt is complete. At this point, the associated values in the various boxes in the receipt may be categorized by a financial management application according to the associations, may be presented to a user, or may be subjected to other forms of processing.

FIG. 6A and FIG. 6B are examples of a computing system and a network, in accordance with one or more embodiments. The one or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6A, the computing system (600) may include one or more computer processor(s) (602), non-persistent storage device(s) (604) (e.g., volatile memory, such as random access memory (RAM), cache memory), persistent storage device(s) (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), and numerous other elements and functionalities that implement the features and elements of the disclosure.

The computer processor(s) (602) may be an integrated circuit for processing instructions. For example, the computer processor(s) (602) may be one or more cores or micro-cores of a processor. The computing system (600) may also include one or more input device(s) (610), such as a touchscreen, a keyboard, a mouse, a microphone, a touchpad, an electronic pen, or any other type of input device.

The communication interface (608) may include an integrated circuit for connecting the computing system (600) to a network (not shown) (e.g., a local area network (LAN), a wide area network (WAN) such as the Internet, a mobile network, or any other type of network) and/or to another device, such as another computing device.

Further, the computing system (600) may include one or more output device(s) (612), such as a screen (e.g., a liquid crystal display (LCD), a plasma display, a touchscreen, a cathode ray tube (CRT) monitor, a projector, or other display device), a printer, an external storage, or any other output device. One or more of the output device(s) (612) may be the same or different from the input device(s) (610). The input and output device(s) (610 and 612) may be locally or remotely connected to the computer processor(s) (602), the non-persistent storage device(s) (604), and the persistent storage device(s) (606). Many different types of computing systems exist, and the aforementioned input and output device(s) (610 and 612) may take other forms.

Software instructions in the form of computer readable program code to perform the one or more embodiments may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform the one or more embodiments.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system (600) shown in FIG. 6A, or a group of nodes combined may correspond to the computing system (600) shown in FIG. 6A. By way of an example, the one or more embodiments may be implemented on a node of a distributed system that is connected to other nodes. By way of another example, the one or more embodiments may be implemented on a distributed computing system having multiple nodes, where each portion of the one or more embodiments may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system (600) shown in FIG. 6A. Further, the client device (626) may include and/or perform all or a portion of the one or more embodiments.

The computing system (600) or group of computing systems described in FIGS. 6A and 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the one or more embodiments. The processes may be part of the same or different application and may execute on the same or different computing system.

Rather than or in addition to sharing data between processes, the computing system performing the one or more embodiments may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the one or more embodiments, may extract one or more data items from the obtained data. For example, the extraction may be performed as follows by the computing system (600) in FIG. 6A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as eXtensible Markup Language (XML)).

The extracted data may be used for further processing by the computing system. For example, the computing system (600) of FIG. 6A, while performing the one or more embodiments, may perform data comparison value determination. A data comparison determination may be used to compare two or more data values (e.g., A, B). For example, one or more embodiments may determine whether A>B, A=B, A!=B, A<B, etc. The comparison value determination may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (600) in FIG. 6A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (a database, a table, a record, a column, a view, etc.), identifiers, conditions (comparison operators), functions (e.g. join, full join, count, average, etc.), sorts (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (600) of FIG. 6A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system (600) of FIG. 6A and the nodes (e.g., node X (622), node Y (624)) and/or client device (626) in FIG. 6B. Other functions may be performed using one or more embodiments.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

What is claimed is:

1. A method comprising:
receiving an electronic record comprising a scan of a physical document;
establishing a coordinate system, unique to the electronic record, for the scan;
generating, automatically, a first boundary, defined according to the coordinate system, around a first set of recognized characters in the scan;
generating, automatically, a second boundary, defined according to the coordinate system, around a second set of recognized characters in the scan, wherein the first set of recognized characters are physically separated in the scan by at least a predetermined distance with respect to the coordinate system;
generating, automatically, a comparison value by comparing a first location of the first boundary to a second location of the second boundary, relative to the coordinate system; and
associating, in storage, the first set of recognized characters with the second set of recognized characters, responsive to the comparison value satisfying a rule.

2. The method of claim 1, wherein the rule comprises an alignment criterion between the first location and the second location, relative to the coordinate system.

3. The method of claim 1, further comprising:
categorizing the first set of recognized characters and the second set of recognized characters according to a policy based, at least in part, on the first location and the second location.

4. The method of claim 1, further comprising:
categorizing the first set of recognized characters and the second set of recognized characters according to a policy based, at least in part, on the first location and the second location,
wherein the policy comprises a set of probabilities that the first set of recognized characters belongs to a selected category type, from among a plurality of category types, based on a vertical distance down from an origin of coordinate system.

5. The method of claim 1, wherein:
generating the comparison value comprises determining whether the first location and the second location are about horizontally aligned with respect to the coordinate system; and
associating comprises assigning the first set of recognized characters as a category and assigning the second set of recognized characters as a value for the category.

6. The method of claim 1, wherein:
the physical document comprises a receipt;
the first set of recognized characters comprises a transaction type; and
the second set of recognized characters comprises a dollar value.

7. The method of claim 1, further comprising:
categorizing automatically, in a financial management application, a transaction type and a dollar value present on the physical document,
wherein categorizing is based, at least in part, on the first location and the second location relative to the coordinate system.

8. The method of claim 1, further comprising:
identifying an alphanumeric pattern in at least one of the first set of recognized characters and the second set of recognized characters; and
categorizing the first set of recognized characters and the second set of recognized characters according to the alphanumeric pattern.

9. The method of claim 1, further comprising:
identifying an alphanumeric pattern in at least one of the first set of recognized characters and the second set of recognized characters;
categorizing the first set of recognized characters and the second set of recognized characters according to the alphanumeric pattern; and
further categorizing the first set of recognized characters and the second set of recognized characters also according to the first location and the second location.

10. A system comprising:
a data repository storing:
an electronic record comprising a scan of a physical document,
a coordinate system, unique to the electronic record, for the scan,
a first boundary, defined according to the coordinate system, around a first set of recognized characters in the scan,
a second boundary, defined according to the coordinate system, around a second set of recognized characters in the scan, wherein the first set of recognized characters are physically separated in the scan by at least a predetermined distance with respect to the coordinate system,
a comparison value that quantifies a degree of difference, relative to the coordinate system, between a first location of the first boundary and a second location of the second boundary, and
a rule that quantitatively defines when the first set of recognized characters is deemed associated with the second set of recognized characters;
a processor in communication with the data repository; and
an application services platform configured, when executed by the processor, to:
receive the electronic record,
establish the coordinate system,
generate, automatically, the first boundary and the second boundary,
generate, automatically, the comparison value by comparing the first location of the first boundary to a second location of the second boundary,
determine that the comparison value satisfies the rule, and
associate, in the data repository, the first set of recognized characters with the second set of recognized characters when the rule is satisfied.

11. The system of claim 10, further comprising:
an image extraction service, executable by the processor to perform optical character recognition on the physical document.

12. The system of claim 10, further comprising:
a web interface, executable by the processor to:
receive the electronic record comprising the scan of the physical document; and
present extracted image data to a graphical user interface of a user device.

13. The system of claim 10, further comprising:
an image data extraction service, executable by the processor to perform optical character recognition on the physical document; and
a data stream management service, executable by the processor to coordinate data communications between the application services platform and the image data extraction service.

14. The system of claim 10, further comprising:
a financial management application, executable by the processor to categorize the first set of recognized characters and the second set of recognized characters according to a policy based, at least in part, on the first location and the second location.

15. A non-transitory computer readable storage medium storing program code, which when executed by a processor, performs a computer-implemented method comprising:
receiving an electronic record comprising a scan of a physical document;
establishing a coordinate system, unique to the electronic record, for the scan;
generating, automatically, a first boundary, defined according to the coordinate system, around a first set of recognized characters in the scan;
generating, automatically, a second boundary, defined according to the coordinate system, around a second set of recognized characters in the scan, wherein the first set of recognized characters are physically separated in the scan by at least a predetermined distance with respect to the coordinate system;
generating, automatically, a comparison value by comparing a first location of the first boundary to a second location of the second boundary, relative to the coordinate system; and
associating, in storage, the first set of recognized characters with the second set of recognized characters, responsive to the comparison value satisfying a rule.

16. The non-transitory computer readable storage medium of claim 15, wherein the rule comprises an alignment criterion between the first location and the second location, relative to the coordinate system.

17. The non-transitory computer readable storage medium of claim 15, wherein the program code, when executed, performs the computer-implemented method to further comprise:
categorizing the first set of recognized characters and the second set of recognized characters according to a policy based, at least in part, on the first location and the second location.

18. The non-transitory computer readable storage medium of claim 15, wherein the program code, when executed, performs the computer-implemented method to further comprise:
categorizing the first set of recognized characters and the second set of recognized characters according to a policy based, at least in part, on the first location and the second location, and
wherein the policy comprises a set of probabilities that the first set of recognized characters belongs to a selected category type, from among a plurality of category types, based on a vertical distance down from an origin of coordinate system.

19. The non-transitory computer readable storage medium of claim 15, wherein:
generating the comparison value comprises determining whether the first location and the second location are about horizontally aligned with respect to the coordinate system; and
associating comprises assigning the first set of recognized characters as a category and assigning the second set of recognized characters as a value for the category.

20. The non-transitory computer readable storage medium of claim 15, wherein:
generating the comparison value comprises determining whether the first location and the second location are about horizontally aligned with respect to the coordinate system;
associating comprises assigning the first set of recognized characters as a category and assigning the second set of recognized characters as a value for the category;
the physical document comprises a receipt, the first set of recognized characters comprises a transaction type, and the second set of recognized characters comprises a dollar value; and
the program code, when executed, performs the computer-implemented method to further comprise:
categorizing automatically, in a financial management application, the transaction type and the dollar value,
wherein categorizing is based, at least in part, on the first location and the second location relative to the coordinate system.
